(19) United States
(12) Patent Application Publication
(10) Pub. No.: US 2024/0269939 A1
(43) Pub. Date: Aug. 15, 2024

(54) Method for Manufacturing Continuous Fiber Composite Frame

(71) Applicant: Euro-Ace Composite Manufacturing Co., Ltd., Taichung City (TW)

(72) Inventor: Ching-Song Shaw, Taichung City (TW)

(21) Appl. No.: 18/337,735

(22) Filed: Jun. 20, 2023

(30) Foreign Application Priority Data
Feb. 14, 2023 (TW) 112105098

(51) Int. Cl. B29C 70/24; B29C 65/08; B29C 65/48; B29C 70/42

(52) U.S. Cl. CPC B29C 70/24; B29C 65/08; B29C 65/48; B29C 70/42; B29K 2307/04; B29K 2309/08

(57) ABSTRACT

A method for manufacturing continuous fiber composite frame having steps of heating at least a portion of a continuous fiber bundle, bending the portion in three-dimensional directions along a fiber axis of the continuous fiber bundle in space, and creating multiple structural units; and bonding multiple connection points of the structural units to create a structural prototype.

### FIELD OF INVENTION

The present invention relates to a method for producing a frame, particularly a continuous fiber composite structure.

### BACKGROUND OF THE INVENTION

Fiber composite materials are widely used in various fields such as sports equipment, construction, wind terbines, transportation, ships, and aerospace, due to their high toughness, high material strength, favorable characteristics, and lightweight. However, the existing fiber composite are often made by plate-like or sheet-like, or cut the desired structure of a whole fiber composite to form a desired structure. These methods result in inferior mechanical properties such as reduced strength and modulus in the final products. Moreover, the process of cutting required sections from the whole fiber composite generates waste material, leading to lower material utilization rates, resource waste, environmental pollution, and increased costs of waste disposal.

In addition, some conventional methods of manufacturing fiber composite are produced by hot pressing. By putting pieces of prepreg fiber cloths or prepreg fiber bundles into the hot pressing mold as constituent units of the part, and then heating them to a temperature exceeding the melting point and pressure of the prepreg fiber cloths or prepreg fiber bundles to form the join. However, such process of manufacturing fiber composite requires heating the entire mold to high temperatures and the process consumes a lot of energy. Additionally, the constituent units may displace and deviate from their intended positions within the mold. Moreover, the constituent units may not attach properly to the mold, resulting in poor molding quality, loss of intricate structures, and reduced part strength.

### SUMMARY OF THE INVENTION

To solve abovementioned problems, this present invention discloses a method for manufacturing continuous fiber composite frame comprising steps of: heating at least a portion of a continuous fiber bundle, bending the portion in three-dimensional directions along a fiber axis of the continuous fiber bundle in space to form multiple structural units, wherein the continuous fiber bundle includes multiple fiber bundles coated with thermoplastic resin; and bonding multiple connection point of the structural units to create a structural prototype.

Wherein, the method further comprises a step of placing the structural prototype into a mold and shaping the structural prototype into a continuous fiber composite frame with compression molding.

Wherein, the connection points are bonded by ultrasonic welding at least two of the connection points.

Wherein, the connection points are bonded by heating and fusing at least two of the connection points.

Wherein, the connection points are bonded by gluing at least two of the connection points.

Wherein, the temperature during the compression molding does not exceed the melting point of the thermoplastic resin.

Wherein, the fiber bundles comprise carbon fiber, glass fiber, aramid fiber, or ceramic fiber.

Wherein, the thermoplastic resin comprises polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC).

Wherein, some or all of the structural units are closed circular structure, with two ends of the structural unit connected together.

Wherein, the method further comprises a step of coating the continuous fiber composites frame with a covering material.

Wherein, the covering material comprises elastic materials, foam materials, porous materials, or resin materials.

Wherein, the covering material comprises thermoplastic polyurethane, ethylene/vinyl acetate copolymer, rubber, or polyolefin.

Wherein, the bending process comprises passing the continuous fiber bundle through a shaper mold after heating, wherein the shaper mold comprises a tubular cavity with a three-dimensional bent cavity.

Wherein, the bending process comprises conveying the continuous fiber bundle to a bending machine, wherein the bending machine bends at least a portion of the continuous fiber bundle.

### BRIEF DESCRIPTION OF THE DRAWINGS

FIG. 1 is a schematic diagram of steps of a method in accordance with this invention.

### DETAILED DESCRIPTION OF THE PREFERRED EMBODIMENTS

Unless otherwise explicitly indicated in the context, terms such as “one,” “a,” “an,” or “the” in this specification and claims are not limited to singular form and may include plural forms. Generally, the terms “comprising” and “including” are used to indicate the presence of explicitly identified steps and elements, but these steps and elements do not preclude the presence of additional steps or elements.

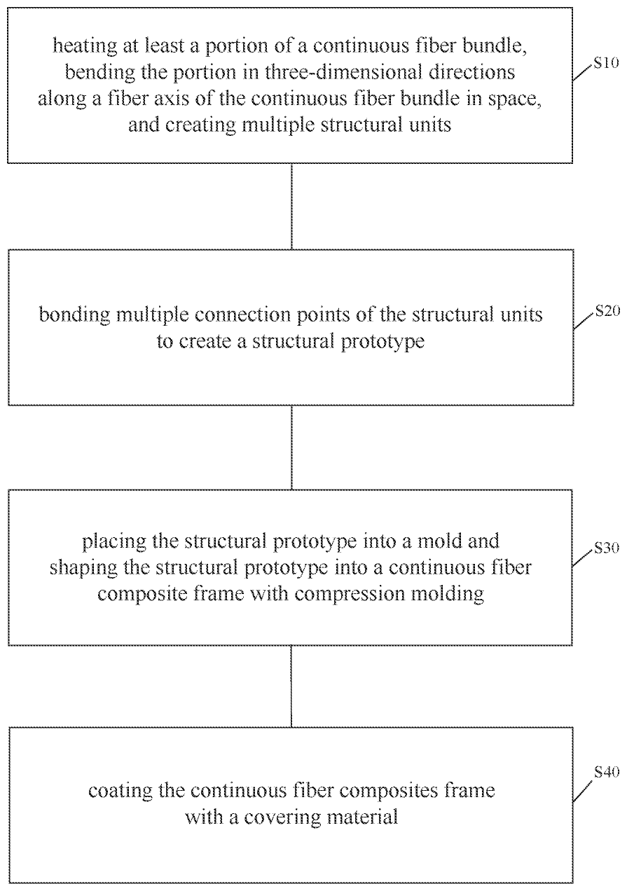

With reference to FIG. 1, a preferred embodiment of the method for manufacturing continuous fiber composite frame in accordance with this invention includes the following steps.

Step S10: Heating at least a portion of a continuous fiber bundle, bending the portion in three-dimensional directions along a fiber axis of the continuous fiber bundle in space to form multiple structural units. The continuous fiber bundle includes multiple fiber bundles coated with thermoplastic resin. In step S10, the continuous fiber bundle is subjected to at least partial heating, and the continuous fiber bundle is bent in three-dimensional directions along the fiber axis in space. By partially heating the already cured and formed continuous fiber bundle, the thermoplastic resin that encapsulates the continuous fiber bundle softens at a heated region. At this point, the heated region becomes flexible and can be bent in three-dimensional space without breaking. The heated region is then cooled, resulting in the multiple structural units with fixed shapes and structures. The terms “coating” and “encapsulation” refers to various methods, including but not limited to impregnation and co-extrusion, to ensure complete adhesion of the thermoplastic resin to the fiber bundles. In one embodiment, the continuous fiber bundle is impregnated with the thermoplastic resin to form a composite material. The thermoplastic resin adheres to and encapsulates the continuous fiber bundle, and the thermoplastic resin is then cooled and solidified. The term “a portion of” referes to a part of the continuous fiber bundle that are designated to be bent.

The fiber material of the continuous fiber bundle may include carbon fiber, glass fiber, aramid fiber, ceramic fiber, or a combination thereof. The thermoplastic resin may include one or a combination of polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC), among other polymer materials or combinations thereof. The term “continuous fiber bundle” refers to a collection of multiple fiber yarns assembled into a bundle, where the fiber yarns maintain continuity in the length direction for at least 2 centimeters, preferably exceeding 10 centimeters. Ideally, the length of the continuous fiber bundle exceeds 1 meter. Most of the fibers in the continuous fiber bundle have a length equal to the length of the long axis of the continuous fiber bundle. The materials used for the fiber bundle can include carbon fiber, glass fiber, aramid fiber, or ceramic fiber.

The term “bending in three-dimensional space” refers to the ability of the continuous fiber bundle to bend in any direction along its longitudinal axis, without being limited to a requirement that any two bends must lie in a common plane. In other words, the continuous fiber bundle can bend in multiple directions freely in three-dimensional space without the constraint of being confined to a single plane. The bending of the continuous fiber bundle can be achieved through various methods. The continuous fiber bundle can be manually bent using hand tools such as pliers, hammers, or nails to achieve the desired shape. Preferably, mechanical bending can be employed by using machinery such as rolling machines, bending machines, or shearing machines to bend the continuous fiber bundle into the desired shape. Another approach is to guide and convey the continuous fiber bundle into a shaper mold, where the continuous fiber bundle can be bent according to the shape of the shaper mold. In a preferred embodiment, the continuous fiber bundle is conveyed to a bending machine and subjected to a heating source to soften at least a part of the continuous fiber bundle. The heating source provides heating at a temperature that is higher than the glass transition temperature of the thermoplastic resin but lower than the thermal decomposition temperature of the thermoplastic resin. The continuous fiber bundle is bent at the locally heated and softened portion using the bending machine. The bending is not limited to bending in the same plane. By rotating the bending machine or rotating the continuous fiber bundle itself, the continuous fiber bundle can be bent in three-dimensional space. Preferably, by continuously feeding the continuous fiber bundle through the bending machine and performing rotation and bending at specified parts of the continuous fiber bundle, the continuous fiber bundle can be sequentially bent in a three-dimensional space from one end to the other end.

In another preferred embodiment, the continuous fiber bundle is passed through the shaper mold after being locally heated. The shaper mold has a three-dimensional curved tubular mold cavity. The continuous fiber bundle is heated at least locally to a temperature above the glass transition temperature of the thermoplastic resin and then guided through the three-dimensional curved tubular mold cavity to a specified position. Afterward, the continuous fiber bundle is cooled and cured before being removed from the shaper mold. In a preferred manner, the continuous fiber bundle is bent within the tubular mold cavity using a rotating wheel that drives the continuous fiber bundle through the tubular mold cavity, causing the continuous fiber bundle to bend. In another preferred embodiment, one end of the continuous fiber bundle is attached to a guide structure. The continuous fiber bundle is guided through the tubular mold cavity by moving and pulling the guiding structure along the tubular mold cavity, thereby inducing the desired bending in the continuous fiber bundle.

Furthermore, the structural units formed by the heating and bending of the continuous fiber bundle can have identical or different structures and shapes.

In particular, some or all of the structural units can form closed ring structures by connecting two radial ends of the continuous fiber bundle. These ring structures can have variable shapes and may have different winding numbers. The term “winding number” refers to the number of times the fiber bundle wraps around itself within the ring structure. This flexibility in ring structure formation enhances the adaptability and versatility of the structural units. In an embodiment, some of the structural units exhibit multiple crossover points, and within or between these structural units, there may be helical or braided winding patterns. The crossover points refer to the locations where the fiber bundles cross over each other within the structural unit, creating intersections. The helical or braided winding patterns involve the twisting and intertwining of the fiber bundles, resulting in a spiral or braided configuration. These intricate winding patterns contribute to the overall structural complexity and enhance the mechanical properties and functionality of the composite material.

In applications involving multiple continuous fiber bundles, the structural units generated by each of the continuous fiber bundles can have completely identical shapes and structures. Alternatively, they can have partially similar or entirely different shapes and structures. This flexibility allows for customization and adaptation to specific design requirements and performance criteria. Depending on the desired outcome, the structural units can exhibit uniformity or variation, enabling the composite material to possess diverse properties and functionalities in different regions or sections. In one embodiment, a portion of the structural units is in the form of closed loop structures, while another portion exhibits different three-dimensional configurations. This combination of closed loop structures and other geometric shapes provides versatility and enhances the overall structural integrity and performance of the composite material. The closed loop structures contribute to load distribution and stability, while the other three-dimensional configurations may serve specific functional or aesthetic purposes. The integration of these different structural elements enables the composite material to meet various design requirements and optimize its performance in different applications.

Furthermore, the fiber bundle materials and the thermoplastic resin composition that encapsulates the fiber bundle materials in each of the continuous fiber bundle can be the same or different for different continuous fiber bundles. This allows for the creation of structural units with different fiber bundle materials and thermoplastic resin compositions, resulting in structural units with varied material properties. By tailoring the combination of fiber bundle materials and thermoplastic resins, specific characteristics such as strength, flexibility, heat resistance, or other desired properties can be achieved in each structural unit.

Furthermore, the cross-sectional size and shape of each continuous fiber bundle can be completely identical, partially identical, or entirely different. This allows for flexibility in designing and tailoring the geometry of each fiber bundle to suit specific application requirements. In one embodiment, a structural unit includes a larger cross-sectional rod and some smaller cross-sectional structural units wrapped around the periphery of the larger cross-sectional rod. In this embodiment, the rod is formed by a continuous fiber bundle, such as continuous carbon fibers, extending in the axial direction and coated with the thermoplastic resin. The external smaller cross-sectional structural units are made of glass fibers coated with the thermoplastic resin. This configuration allows the larger cross-sectional rod to serve as a central axis, while the wrapping of smaller cross-sectional structural units further enhances the radial and circumferential strength and resilience of the central axis.

Step S20: Bonding multiple connection points of the structural units to create a structural prototype. The term “bonding” refers to the fixation of the at least two corresponding connection points by connecting them together. The term “connection point” refers to a local position within the structural unit. The connection point can be mutually fixed with another connection point. The bonding between at least two corresponding connection points can occur between two or more connection points within the same structural unit, or between different connection points on two or more different structural units. The term “bond” denotes the process of securely fastening two or more connection points together. Furthermore, the mutual bonding of multiple connection points also includes the arrangement where consecutive connection points form a linear or even planar configuration of connection. In one embodiment, two ring-shaped structural units each have a series of consecutive connection points forming a connecting line. The connecting lines on each structural unit are mutually bonding, resulting in at least a partial linear connection between the two structural units.

The methods of bonding the connection points in step S20 include, but are not limited to, welding, fusion bonding, soldering, compression bonding, adhesive bonding, and other similar techniques. In a first preferred embodiment, ultrasonic welding is used as a method to bond the connection points. A high-frequency wave signal is generated by a transducer of an ultrasonic welding machine, and an ultrasonic energy is transmitted to at least two corresponding and contacting connection points with a welding head of the ultrasonic welding machine. The ultrasonic energy causes the contact surfaces to melt and fuse together, resulting in the connection points being connected. The welding head may apply moderate pressure during the ultrasonic welding to ensure a tight and secure bond between the connection points. In a second preferred embodiment, the method of bonding the connection points in step S20 involves locally heating and contacting the at least two connection points above the melting temperature of the thermoplastic resin covering the connection points. The contact between the connection points is maintained until the locally heated area cools down and the thermoplastic resin is cured and solidified, thereby bonding the connection points together as intended. In a third preferred embodiment, step S20 involves gluing at least a portion of the connection points using a thermoplastic resin material. The thermoplastic resin material used for gluing can have the same or different composition as the thermoplastic resin that covers the continuous fiber bundle of each structural unit. In a fourth preferred embodiment, step S20 involves applying a solvent that dissolves the thermoplastic resin of the structural units onto at least a portion of the connection points. The corresponding connection points are then brought into contact. After the solvent has evaporated, the corresponding connection points are brought into contact, resulting in the mutual bonding of the connection points.

In a preferred embodiment, two ends of the continuous fiber bundle are two of the connection points and are bonded together, eliminating any noticeable endpoints of the continuous fiber bundle.

The structural prototype is formed after the multiple connection points of the structural units are bonded and cured. The structural prototype can be used as a continuous fiber composite frame without further processing, or the structural prototype can be further modified or processed through subsequent steps. In one embodiment, the connection points of the multiple structural units are bonded together to form a structural prototype. The structural prototype can be selectively trimmed or perforated in specific areas to create more intricate configurations while maintaining the overall structural integrity and enhancing efficiency of manufacturing.

Step S30: Placing the structural prototype into a mold and shaping the structural prototype into a continuous fiber composite frame with compression molding. In step S30, the structural prototype formed in step S20 is placed into one of the cavities of the mold. The mold is then closed, and pressure and heat are applied to the mold. The structural prototype is soften and undergo bending and deformation. The structural prototype thus conforms to the shape of the mold and forms the continuous fiber composite frame with curved surfaces and surface textures. This can be achieved by incorporating features in the design of the mold, such as contours, textures, or embossing, which will be transferred onto the surface of the thermoplastic resin as it softens and conforms to the mold. By carefully designing the mold cavity, desired curves, shapes, and surface patterns can be imparted onto the structural prototype, resulting in desired curved surfaces and various surface textures. The mold is subsequently cooled, causing the thermoplastic resin to cure. The cooling and curing of the thermoplastic resin in the mold then preserves these features, allowing for the production of a continuous fiber composite frame with desired surface characteristics. The continuous fiber composite frame can then be removed from the mold.

In one embodiment, the mold is applied only to specific regions of the structural prototype, thereby altering a part of curvatures and surface textures of the structural prototype and enhancing the strength of the connection points at the same time. In another embodiment, the entire structural prototype is fully enclosed within the mold for shaping.

Preferably, the temperature of the mold does not exceed the melting point of the thermoplastic resin. Heating below the melting point prevents undesired melting of the thermoplastic resin and subsequent displacement of the fiber bundles within the mold. Therefore, intricate structures of the continuous fiber composite frame are preserved, and the continuous fiber composite frame does not require any further secondary processing. This control of the temperature ensures that the desired shape and structural features are maintained during the compression molding. Moreover, the heat source inputted into the mold exceeds the glass transition temperature (Tg) of the thermoplastic resin. Preferably, the heating temperature should exceed the heat distortion temperature (HDT) of the thermoplastic resin but should not exceed the temperature of the melting point of the thermoplastic resin. Preferably, in embodiments where the structural prototypes are composed of two or more thermoplastic resins with different melting points, the heating temperature to the mold should not exceed the melting point of the thermoplastic resin with the highest melting point. Since the connection points of the structural prototype are all bonded before step S30, the heat input required for the mold used in the compression molding process can be significantly reduced compared to traditional high-temperature molding. Additionally, the positioning of the mold can be more flexible. The mold can be selectively applied only to the surface of the structural prototype to modify the surface of the structural prototype or to enhance the bonding strength of the connection points.

Step S40: Coating the continuous fiber composites frame with a covering material. In this step S40, the method for manufacturing the continuous fiber composite frame further includes enveloping the continuous fiber composites frame with the covering material. Step S40 is an optional step in the method in accordance with this present invention. The covering material serves to enhance and protect the continuous fiber composite frame. Therefore, use of the covering material expands the range of applications for the continuous fiber composite frame, making it versatile and widely applicable. The continuous fiber composite frame creates a rigid structure along the axis of the continuous fiber bundle, providing strong rigidity, while the covering material offers a buffer against radial forces applied to the continuous fiber composite frame, preventing the fracture of the continuous fiber composite frame. Preferably, the covering material contains at least one species selected from the group consisting of elastic materials, foam materials, porous materials, or resin materials. Among them, the resin material can be either a thermosetting resin or a thermoplastic resin. If the resin material is a thermoplastic resin, the resin material can have the same or different composition as the thermoplastic resin of the continuous fiber composite frame. Furthermore, the resin material may contain fibers, wherein the fibers can be either continuous fibers or short fibers. The incorporation of fibers into the resin material can enhance strength, rigidity, and wear resistance of the resin material.

In some embodiments, the continuous fiber composite frame is placed in a second mold. Using injection molding or insert molding techniques, the covering material is injected into the second mold to form a protective layer or foam covering around the continuous fiber composite frame. Furthermore, the covering material can be composed of thermoplastic polyurethane, ethylene/vinyl acetate copolymer, rubber, or polyolefin, among other components. This allows the method in accordance with present invention to generate the continuous fiber composite frames for shoe soles. Once the continuous fiber composite frame is completed, it can be further coated with the covering material.

The method in accordance with present invention can be applied to various applications including, but not limited to frameworks of electronic devices such as mobile phones, screens, laptops, AR/VR hardware. The continuous fiber composite frame can also be used for eyeglass frames, golf club heads, specialized shoe soles, and structural components of various sports products. The versatility of the method allows for the creation of durable and lightweight structures in a wide range of industries and products.

Based on the aforementioned description, the present invention has the following advantages:

1. The method for manufacturing the continuous fiber composite frame in accordance with the present invention involves pre-joining the connection points of the structural units before compression molding. This reduces the heating temperature required for compression molding, resulting in significant energy savings.

2. The method for manufacturing the continuous fiber composite frame in accordance with the present invention involves pre-joining the connection points of the structural units before compression molding. The reduction of the heating temperature required for compression molding avoids heating up a temperature above the melting point of the thermoplastic resin which would cause the displacement of continuous fibers and the damage to the pre-preg fiber bundle structure and surface structure, thereby preserving the reduction of the strength of the continuous fiber composite frame. Additionally, this method reduces the time and cost associated with secondary processing.

3. The method for manufacturing the continuous fiber composite frame in accordance with the present invention involves pre-joining the connection points of the structural units before compression molding. The reduction of heating temperature required for compression molding significantly reduces the time required for heating and cooling, and greatly increases production efficiency. Moreover, the reduced heating temperature helps minimize deformation of the mold and result in a smoother surface and improves accuracy of the continuous fiber composite frame. This enables the production of complex continuous fiber composite frames with intricate structures. Additionally, this method significantly increases the lifespan of the mold.

4. The method for manufacturing the continuous fiber composite frame in accordance with the present invention involves pre-joining the connection points of the structural units before compression molding, thereby reducing the heating temperature required for compression molding. This allows for a more diverse and flexible selection of mold materials, eliminating the need for expensive molds with high melting points and low thermal deformation requirements in traditional high-temperature molding processes. As a result, the method in accordance with this invention helps reduce the overall cost of molds and improve the process.

5. The method for manufacturing the continuous fiber composite frame in accordance with the present invention involves pre-joining the connection points of the structural units before compression molding. This preforming process allows for more precise control over the fine structure of the frame and ensures the quality of the formation of the continuous fiber composite frame. As a result, the method in accordance with this invention achieves configurations and levels of precision that cannot be attained by traditional methods of assembling individual components using compression molding.

6. The method for manufacturing the continuous fiber composite frame in accordance with the present invention involves pre-joining the connection points of the structural units before compression molding. The reduction of the heating temperature required for the compression molding process leads no need to heat the structural units above the melting point of the thermoplastic resin. This prevents excessive softening of the structural units and uncontrollable flow of the thermoplastic resin during the compression molding process of the structural prototype. Furthermore, by eliminating the need to fully enclose the structural prototype in the mold during the compression molding process, the mold can be placed more flexibly and with greater versatility. Localized compression molding can be applied to specific areas of the structural prototype without affecting other parts of the structural prototype. This leads to cost savings in mold production and eliminates size limitations imposed by the dimensions of the mold. As a result, the method in accordance with this invention makes it possible to produce large-scale and complex continuous fiber composite frames.

7. The method for manufacturing the continuous fiber composite frames in accordance with this invention uses continuous fiber bundles, which helps in conserving production materials, increasing material utilization rates, and reducing waste. As a result, the method in accordance with this invention lowers manufacturing costs and minimizes waste disposal.

8. The method in accordance with present invention utilizes thermoplastic resin as the base material for the continuous fiber composite frames, making the continuous fiber composite frames recyclable and reusable at the end of its lifecycle. The method in accordance with this invention achieves the benefits of promoting green and environmentally friendly practices. This approach helps reduce waste, conserve resources, and minimize the environmental impact associated with the production and disposal of the continuous fiber composite frames.

9. The continuous fiber composite frame manufactured by the method in accordance with this invention can form a three-dimensional framework in space, offering a high degree of design freedom. The method in accordance with this invention allows for the fabrication of complex components and enables highly customized and integral formation of the continuous fiber composite frame, and the method greatly increase structural integrity of the continuous fiber composite frame. This approach significantly enhances the mechanical performance of the continuous fiber composite frame, providing high structural strength and a high elastic modulus for various applications. Additionally, the method in accordance with this invention can further combines multiple continuous fiber composite frame or further coats the continuous fiber composite frame with the covering material, offering various configuration and a high level of flexibility.

What is claimed is:

1. A method for manufacturing continuous fiber composite frame comprising steps of:
heating at least a portion of a continuous fiber bundle, bending the portion in three-dimensional directions along a fiber axis of the continuous fiber bundle in space to form multiple structural units, wherein the continuous fiber bundle includes multiple fiber bundles coated with thermoplastic resin; and
bonding multiple connection points of the structural units to create a structural prototype.

2. The method for manufacturing continuous fiber composite frame according to claim 1, wherein the method further comprises a step of placing the structural prototype into a mold and shaping the structural prototype into a continuous fiber composite frame with compression molding.

3. The method for manufacturing continuous fiber composite frame according to claim 1, wherein the connection points are bonded by ultrasonic welding at least two of the connection points.

4. The method for manufacturing continuous fiber composite frame according to claim 1, wherein the connection points are bonded by heating and fusing at least two of the connection points.

5. The method for manufacturing continuous fiber composite frame according to claim 1, wherein the connection points are bonded by gluing at least two of the connection points.

6. The method for manufacturing continuous fiber composite frame according to claim 2, wherein the temperature during the compression molding does not exceed the melting point of the thermoplastic resin.

7. The method for manufacturing continuous fiber composite frame according to claim 1, wherein the fiber bundles comprises carbon fiber, glass fiber, aramid fiber, or ceramic fiber.

8. The method for manufacturing continuous fiber composite frame according to claim 1, wherein the thermoplastic resin comprises polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC).

9. The method for manufacturing continuous fiber composite frame according to claim 1, wherein some or all of the structural units are closed circular structure, with two ends of the structural unit connected together.

10. The method for manufacturing continuous fiber composite frame according to claim 2, wherein some or all of the structural units are closed circular structure, with two ends of the structural unit connected together.

11. The method for manufacturing continuous fiber composite frame according to claim 1, wherein the method further comprises a step of coating the continuous fiber composites frame with a covering material.

12. The method for manufacturing continuous fiber composite frame according to claim 2, wherein the method further comprises a step of coating the continuous fiber composites frame with a covering material.

13. The method for manufacturing continuous fiber composite frame according to claim 11, wherein the covering material comprises elastic materials, foam materials, porous materials, or resin materials.

14. The method for manufacturing continuous fiber composite frame according to claim 11, wherein the covering material comprises thermoplastic polyurethane, ethylene/vinyl acetate copolymer, rubber, or polyolefin.

15. The method for manufacturing continuous fiber composite frame according to claim 12, wherein the covering material comprises thermoplastic polyurethane, ethylene/vinyl acetate copolymer, rubber, or polyolefin.

16. The method for manufacturing continuous fiber composite frame according to claim 13, wherein the covering material comprises thermoplastic polyurethane, ethylene/vinyl acetate copolymer, rubber, or polyolefin.

17. The method for manufacturing continuous fiber composite frame according to claim 1, wherein the bending process comprises passing the continuous fiber bundle through a shaper mold after heating, wherein the shaper mold comprises a tubular cavity with a three-dimensional bent cavity.

18. The method for manufacturing continuous fiber composite frame according to claim 2, wherein the bending process comprises passing the continuous fiber bundle through a shaper mold after heating, wherein the shaper mold comprises a tubular cavity with a three-dimensional bent cavity.

19. The method for manufacturing continuous fiber composite frame according to claim 1, wherein the bending process comprises conveying the continuous fiber bundle to a bending machine, wherein the bending machine bends at least a portion of the continuous fiber bundle.

20. The method for manufacturing continuous fiber composite frame according to claim 2, wherein the bending process comprises conveying the continuous fiber bundle to a bending machine, wherein the bending machine bends at least a portion of the continuous fiber bundle.
